(19) United States
(12) Patent Application Publication
(10) Pub. No.: US 2017/0212777 A1
(43) Pub. Date: Jul. 27, 2017

(54) VIRTUAL SERVER OPERATION CONTROL SYSTEM AND VIRTUAL SERVER OPERATION CONTROL PROGRAM

(71) Applicant: HITACHI SYSTEMS, LTD., Tokyo (JP)

(72) Inventor: Mineyuki TAMURA, Tokyo (JP)

(21) Appl. No.: 15/324,735

(22) PCT Filed: Jul. 7, 2014
(86) PCT No.: PCT/JP2014/068069

§ 371 Date: Jan. 9, 2017

(51) Int. Cl. G06F 9/455; G06F 9/48

(52) U.S. Cl. CPC G06F 9/45558; G06F 9/4881; G06F 2009/45595; G06F 2009/45575; H04L 67/10

(57) ABSTRACT

A technique is provided, by which in performing control over operations including the activation and stoppage of a virtual server system on a public cloud, normal and detailed control meeting the convenience and time requirements of a client company can be achieved. A virtual server operation control system includes a server that controls the status of operations including the activation and stoppage of a virtual server system for a client company on a public cloud. Based on setting, the server creates schedule information of operation control including the activation and stoppage of a plurality of virtual servers making up the virtual server system. The server sends an instruction to start or stop the plurality of virtual servers, to a target public cloud at a scheduled date, thereby causes the public cloud to start or stop the virtual server system.

### TECHNICAL FIELD

The present invention relates to a technique for computers and information processing. The present invention also relates to a technique for controlling the operation status of a virtual server or a virtual machine.

### BACKGROUND ART

Conventionally, in a computer system including a cloud computing system such as a public cloud on the Internet, a system composed of virtual servers, etc., on physical servers (hereinafter, referred to as “virtual server system”) is operated. A service provider operates a virtual server system on such a system as a public cloud, and offers the system that is paid as much as a client uses, etc., charging in accordance with the operating time of the virtual server or others to an organization such as a client company. The client company accesses the virtual server system on the public cloud through a terminal and uses the services and functions of the virtual server system.

Conventionally, there are a basic technique for controlling activation, stoppage, etc., of the physical servers and the virtual servers, a technique for controlling the number of the operated virtual servers in accordance with a load, and others.

Japanese Patent Application Laid-Open Publication No. H06-337738 (Patent Document 1) is cited as an example of the related art regarding the control for the operation of the above-described physical server and virtual server. The Patent Document 1 describes control for switching on/off of a power supply to a calculator via a network based on settings of a schedule management DB.

### RELATED ART DOCUMENT

### Patent Document

Patent Document 1: Japanese Patent Application Laid-Open Publication No. H06-337738

### SUMMARY OF THE INVENTION

### Problems to be Solved by the Invention

Conventionally, there are many cases in which the above-described virtual server system for the client company on the public cloud is managed and used so as to be constantly operated, that is, so that a plurality of virtual servers are constantly activated. The client company desires to reduce a cost to be paid as much as the client uses. For this, stoppage of the virtual server at a time convenient to the client company to reduce the operating time of the virtual server is conceivable. For example, the stoppage is managed on holidays, during non-business hours, etc. However, in this case, the management invests time and effort in work such as manual instructions, setting, etc., for the stoppage, the reactivation, and others. Besides, control for the stoppage, etc., cannot be sufficiently achieved in some cases because of the following unique problems. For this reason, the virtual server system is managed and used so as to be constantly operated as described above in many cases, and it is difficult to reduce the operating time of the virtual server, etc., and therefore, the cost to be paid as much as the client uses cannot be reduced.

When the service provider or client company controls the reactivation or the stoppage of the virtual server system at the time convenient to the client company, the control for the stoppage or others cannot be sufficiently achieved in some cases because of characteristics and limitation of each public cloud and each virtual server system. When the virtual server system is reactivated or stopped, predetermined procedures are required for each public cloud and each virtual server system. Basic control for the activation and the stoppage of the virtual server is technically achieved by usage of means as an API that is open to the public on the public cloud and by usage of means such as an instruction and a control setting based on a script program.

For example, when the virtual server is stopped, a system that performs the above-described control (hereinafter, referred to also as “operation control system”) issues an instruction to stop the virtual server, to the public cloud through the API. If there is a process such as batch processing executed by the virtual server, the public cloud waits for the end of the process, and then, stops the virtual server.

Even the instruction to stop the virtual server is issued simply by the above-described means, the virtual server cannot be normally stopped in some cases because of functional limitation of each public cloud, e.g., each OS of the virtual server. One example of the functional limitation of the OS is a time limit on a process at the time of shutdown. When the above-described the stop instruction is issued, if the end of the process is not completed within a specified time limit, stoppage of the virtual server in the middle or an error, etc., results in some cases. Conventionally, a mechanism that properly controls the stoppage, etc., has not been provided so far in consideration of a situation, characteristics, limitations, etc., at the stoppage of the virtual server for each of the public clouds.

A plurality of virtual servers making up the virtual server system have a predetermined relation among them, and therefore, it is required to consider procedures for properly activating and stopping the virtual servers in the control. Such procedures include, for example, a procedure of stopping a second virtual server before stopping a first virtual server. Conventionally, a mechanism that properly controls the stoppage, etc., has not been provided so far in consideration of the above-described relation.

In the case of the above-described control in accordance with the time, the client company needs to, through the API, manually issue an instruction, etc., with contents in consideration of the characteristics of each of the public cloud or the virtual server system. The client company needs the works such as manual creation, setting, and proper change of the setting of script programs, etc., including the instruction and the control for each time, thus invests time, effort and a large management cost.

Note that the technique as described in the Patent Document 1 is equivalent to a technique of controlling switching on/off of a power supply to a physical server, and does not take into consideration a problem related to the activation and the stoppage of the virtual server on the physical server, and therefore, is not enough to be applied to the control for the operation of the virtual server system in accordance with the time.

An object of the present invention relates to the control for operations including the activation and the stoppage of the virtual server system on the system such as the public cloud, and is to provide a technique of achieving normal and detailed control in accordance with the convenience and time requirements of the client companies and of reducing the cost to be paid as much as the client uses, the time and effort for the setting work, and others.

### Means for Solving the Problems

In order to achieve the above-described object, a typical embodiment of the present invention provides a virtual server operation control system or others that is a system controlling an operation of a virtual server system on such a computer system as a public cloud, and has a feature including the following configuration.

A virtual server operation control system according to an embodiment includes a server device that controls a status of operations including activation and stoppage of a virtual server system of an organization on a computer system including a public cloud. The server device has: a schedule unit that creates schedule information of the control for the operations including the activation and stoppage of the virtual server system at a time convenient to the organization based on an operation on a terminal by a setting administrator of the organization; and a control unit that executes a process of controlling the operation of the virtual server system on the computer system at date and time specified by the schedule information. At the date and time for the activation of the virtual server system, the control unit instructs the computer system to activate a plurality of virtual servers making up the virtual server system, and confirms the completion of the activation through the computer system. At the date and time for the stop of the virtual server system, the control unit instructs the computer system to stop the plurality of virtual servers making up the virtual server system, and confirms the completion of the stop through the computer system.

### Effects of the Invention

According to a typical embodiment of the present invention, in relation to the control for operations including the activation and the stoppage of the virtual server system on the system such as the public cloud, normal and detailed control in accordance with the convenience and time requirements of the client company can be achieved, so that the cost to be paid as much as the client uses, the time and effort for the setting work, and others can be reduced.

### BRIEF DESCRIPTIONS OF THE DRAWINGS

FIG. 1 is a diagram illustrating a configuration of an overall system including a virtual server operation control system according to one embodiment of the present invention;

FIG. 2 is a diagram illustrating a configuration of the virtual server operation control system according to one embodiment;

FIG. 3 is a diagram illustrating an example of a virtual server system of a public cloud according to one embodiment;

FIG. 4 is a diagram illustrating an example of the virtual server system according to one embodiment;

FIG. 5 is a diagram illustrating an example of setting and schedule creation according to one embodiment;

FIG. 6 is a diagram illustrating an example of execution of virtual server operation control according to one embodiment;

FIG. 7 is a diagram illustrating an example of a process at the time of the activation of the virtual server system according to one embodiment of the present invention;

FIG. 8 is a diagram illustrating an example of a process at the time of the stoppage of the virtual server system according to one embodiment;

FIG. 9 is a diagram illustrating an example of a calendar information setting screen according to one embodiment;

FIG. 10 is a diagram illustrating a configuration example of the calendar information according to one embodiment;

FIG. 11 is a diagram illustrating a configuration example of operation control definition information according to one embodiment;

FIG. 12 is a diagram illustrating a configuration example of server definition information according to one embodiment;

FIG. 13 is a diagram illustrating a configuration example of schedule information according to one embodiment;

FIG. 14 is a diagram illustrating a configuration example of operation status information according to one embodiment;

FIG. 15 is a diagram illustrating a first example of an operation control definition information setting screen according to one embodiment;

FIG. 16 is a diagram illustrating a second example of the operation control definition information setting screen according to one embodiment;

FIG. 17 is a diagram illustrating an example of an operation control schedule confirmation screen according to one embodiment; and

FIG. 18 is a diagram illustrating an example and effects of an operation control according to one embodiment, in comparison with conventional example.

### DETAILED DESCRIPTION OF PREFERRED EMBODIMENTS

Hereinafter, embodiments of the present invention will be described in detail with reference to the accompanying drawings. Note that the same components are denoted by the same reference symbols throughout all the drawings for describing the embodiments, and the repetitive description thereof will be omitted. A virtual server operation control system of the present embodiment includes a configuration including the following features.

(1) The present system provides a technical mechanism that controls operations including activation and stoppage of a virtual server system in normal and detail on a schedule convenient to a client company in consideration of characteristics and limitations of each public cloud and each virtual server system. Specifically, the present system includes an automation mechanism of a process executed before stoppage of a virtual server, using an agent, etc., for controlling the operation of the virtual server. In the present system, when the virtual server system is stopped, the virtual server is stopped after a necessary end process in consideration of the characteristics and the limitations of each public cloud and each virtual server system.

(2) The present system provides a mechanism that normally and easily activates and stops a plurality of virtual servers making up a unit virtual server system. Specifically, based on simple setting made by a user of the client company, the present system executes a process of a procedure for activating and stopping the plurality of virtual servers of the virtual server system in a proper order.

(3) Based on simple setting made by the user of the client company, the present system creates a schedule of detailed operation control from the client company's working calendar showing business days, etc., and automatically executes control for operations including the activation and stoppage of the virtual server system in accordance with the schedule. The present system provides a setting screen, etc., serving as an interface that allows the user of the client company to make simple setting, etc. On the screen, the user can easily set and confirm the client company's working calendar, a configuration of the virtual server system, operation control definition information, and others.

[Overall System]

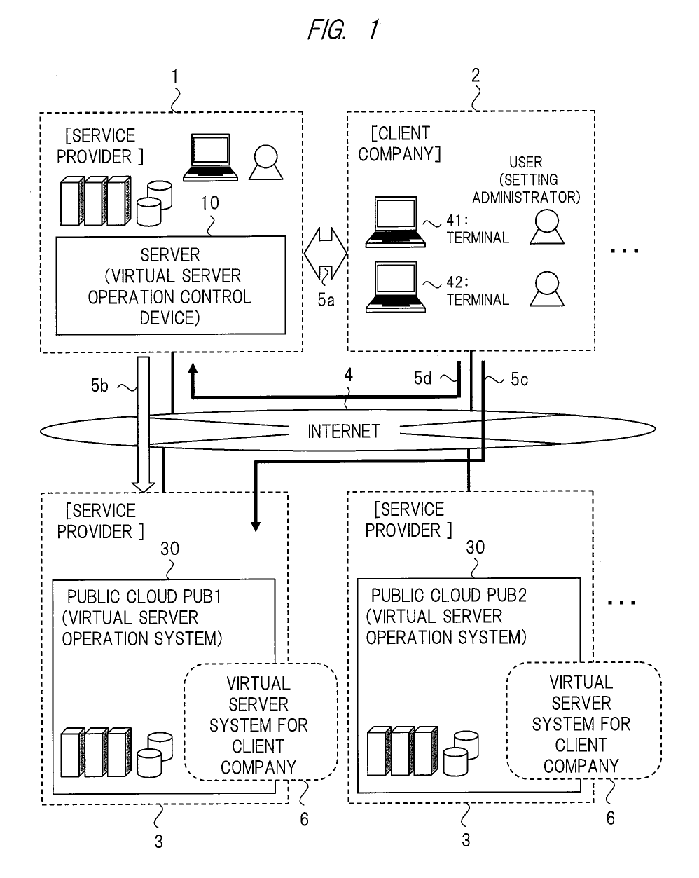

FIG. 1 illustrates a configuration of an overall system including the virtual server operation control system according to one embodiment. In the overall system, a system including a server 10 of a service provider 1, a system including respective terminals 41 and 42 of a plurality of client companies 2, and a system including respective public clouds 30 of a plurality of service providers 3 are connected to one another through the Internet 4 serving as a communication network.

The server 10 of the service provider 1 is, in other words, a virtual server operation control device. The system of the service provider 1 may include devices except for the server 10. The server 10 may be provided as a server system, etc., composed of a plurality of server devices, storage devices, and others. The system of the service provider 1 and the public cloud 30 of the service provider 3 are placed in different locations on the communication network from each other.

The system of the client company 2 includes respective terminals 41 and 42 of a plurality of users, and may include devices such as servers except for the terminals 41 and 42. The users of the client company 2 include an ordinary user such as an employee and a user such as a system administrator who is a person setting the present system. The ordinary user uses the terminal 42 to perform tasks. The setting administrator uses the terminal 41 to perform tasks and to set the present system or others.

The public cloud 30 of the service provider 3 is, in other words, a virtual server operating system including a physical server, a storage, communication equipment and others. The public cloud 30 is a publicly-known computer system that provides a service process using a cloud computing on the Internet 4 to unspecified users including a company and others. On the public cloud 30, the virtual server system 6 for the client company 2 is configured and operated by using resources including hardware and software of the public cloud. Respective public clouds 30 of the plurality of service providers 3 are different from each other in internal mechanism and characteristics.

A reference character “5a” shows that the service provider 1 makes a contract with the client company 2 so that the service provider 1 provides services such as operation/maintenance including the control for the operation of the virtual server system 6 to the client company 2. A reference character “5b” shows that the server 10 accesses the public cloud 3 to control the operation of the virtual server system 6. A reference character “5c” shows that the terminals 41 and 42 of the client company 2 properly access the virtual server system 6 on the public cloud 30 to use a service process using the virtual server system 6, etc. A reference character “5d” shows that the terminal 41 of the setting administrator accesses the server 10 to confirm the settings, operation control contents, etc., of the present system.

Note that the setting administrator of the present system is not limited to a system administrator, etc., in the client company 2 but may be an administrator, a person in charge, etc., in the service provider 1 or an administrator, etc., in the service provider 3.

[Virtual Server Operation Control System]

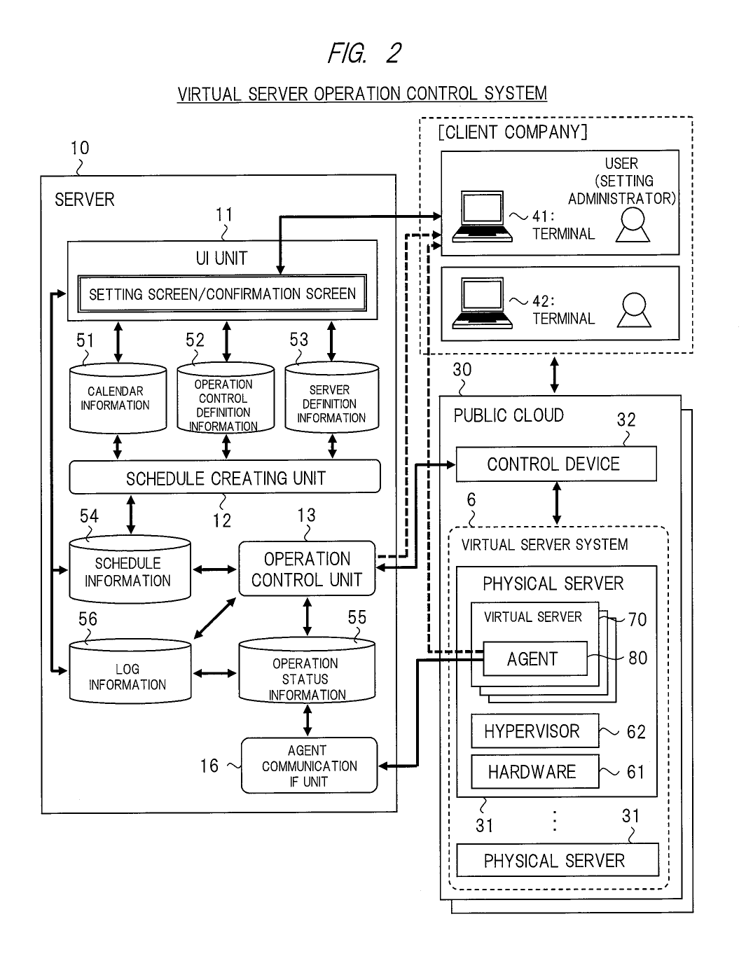

FIG. 2 illustrates a configuration of the virtual server operation control system according to one embodiment. The virtual server operation control system according to one embodiment is mainly composed of the server 10, more specifically, is composed of a link between the terminal 41 of the client company 2 and the public cloud 30. In the present system, in order to control an operation status of a virtual server 70 of the virtual server system 6, an agent 80 is provided in the public cloud 30 as a component.

As processing units, the server 10 has a UI unit 11, a schedule creating unit 12, an operation control unit 13, and an agent communication IF unit 16. As stored and managed data/information, the server 10 has calendar information 51, operation control definition information 52, server definition information 53, schedule information 54, operation status information 55, and log information 56.

The server 10 includes publicly-known elements which are a processor such as MPU, storage devices such as ROM, RAM, and discs, buses, communication interfaces, input/output devices, and others. Each processing unit of the server 10 is achieved by, for example, software programming. In the server 10, each of the above-described processing units is achieved by, for example, causing the MPU to load a program of the present embodiment stored in the RAM, etc., into the ROM, etc., and to execute the program. Each piece of information in the server 10 is stored in, for example, a table in a DB. Each piece of information in the server 10 may be stored in a device outside the server 10.

Each of the user terminals 41 and 42 is composed of a PC, a computer of a smartphone, or others, and is provided with publicly-known elements such as a Web browser and mail client.

The public cloud 30 includes a plurality of physical servers and a management device 32. Each physical server 31 has predetermined hardware 61 and hypervisor 62. The hypervisor 62 is a virtualizing software, and created one or more virtual servers 70 including an OS as an instance using resources including the hardware 61, and operates the virtual server(s). The hypervisor 62 activates or stops the virtual server 70 in response to an instruction. In the public cloud 30, an API (application program interface) for controlling the virtual server 70 that is open to the public on the Internet 4. Note that the public cloud 30 may be a system that operates a virtual machine, using such a software as VMware (registered trademark). In this case, targets on the operation control are the virtual machine and a system configured by the virtual machine.

The management device 32 is a component included in each public cloud 30, and manages the physical server 31 and the virtual server 70. The management device 32 has, for example, a function of controlling switching on/off of the power supply to the physical server 31 and controlling the activation/stoppage of the virtual server 70. The management device 32 activates or stops the virtual server 70 in response to an instruction from the operation control unit 13 of the server 10.

The virtual server 70 operates on the physical server 31, and the agent 80 is operated as a process in the virtual server 70. The agent 80 is activated and stopped by an OS in the virtual server 70. The agent 80 has, for example, a one-to-one correspondence with the virtual server 70 in one-to-one relation, and is activated by the activation of the virtual server 70 and is stopped by the stoppage of the virtual server 70.

The agent 80 is a processing unit that cooperates with the server 10. The agent 80 recognizes the status of operation of the virtual server 70 on the physical server 31, and performs processes required for the control for the activation/stoppage of the virtual server 70 in consideration of the characteristics and the limitations of each public cloud 30. Particularly, the agent 80 has a function of executing an end process which is a pre-process executed in stopping the virtual server 70, in cooperation with the operation control unit 13. The agent 80 periodically accesses the agent communication IF unit 16 of the server 10 to read/write the operation status information 55 via the agent communication IF unit 16. Through this process, the agent 80 refers to or updates information related to the operation control. The agent 80 also has a function of notifying the user terminal 41 of occurrence of an error described later or others if needed.

In the server 10, the UI unit 11 provides a GUI including a setting screen and a confirmation screen as a user interface for the setting administrator. The UI unit 11 is composed of, for example, a Web server, etc., and provides a screen based on a Web page. Based on an operation through the setting administrator's terminal 41, the UI unit 11 provides a setting screen and a confirmation screen for setting and confirming the calendar information 51, operation control definition information 52, server definition information 53, etc. The UI unit 11 stores information set on the setting screen into the calendar information 51, operation control definition information 52, and server definition information 53. The UI unit 11 also provides a confirmation screen to organize and display setting information, the log information 56, an operation control schedule, etc.

Based on the setting information such as the calendar information 51, operation control definition information 52, and server definition information 53, the schedule creating unit 12 creates the schedule information 54 of the operation control. The schedule information 54 is the information including such a schedule as the date and time of the operation control.

The operation control unit 13 is the unit that controls the operation of the virtual server system 6 and of the virtual server 70. The operation control unit 13 executes the operation control for the virtual server system 6 of the public cloud 30 based on date and time and on contents following the schedule information 54. At this time, the operation control unit 13 executes this operation control while properly reading/writing the status information 55 and cooperating with the agent 80. The operation control unit 13 gives an instruction to activate or stop the virtual server 70, using the API of the public cloud 30. The operation control unit 13 writes a status of a current operation control into the operation status information 55. The operation control unit 13 also records history information of the operation control processes including a series of instructions and statuses, into the log information 56. The operation control unit 13 has a function of notifying the user terminal 41 of occurrence of an error described later or others.

The agent communication IF unit 16 is a module that plays a role of an interface for communication with the agent 80, and reads and writes the operation status information 55 in response to access from the agent 80. The agent 80 invokes the agent communication IF unit 16 to make polling to the operation status information 55. That is, the agent 80 periodically refers to the operation status information 55 via the agent communication IF unit 16 and reads/writes the content of the operation status information 55. The agent 80 receives a status change of the operation control for the operation status information 55, and, for example, starts such a process as the end process.

According to the present embodiment, the server 10 does not make access to the agent 80. Instead, the agent 80 always makes polling access to the server 10. The operation control unit 13 does not directly make an instruction to the agent 80, and performs instructions and control through the operation status information 55.

Note that the server 10 can directly make an instruction to the agent 80. However, for this, the agent 80 must have such information as a global IP address. Having this may cause a problem related to cost and security, and becomes the limitation of the achievement and use of the present system. For this reason, according to the present embodiment, the agent 80 makes polling access to the operation status information 55 of the server 10 to establish indirect communication between the operation control unit 13 and the agent 80. In this manner, the agent 80 is not required to have such information as the global IP address, and therefore, the present system can be achieved and used.

The calendar information 51 includes not only the information of the general calendar days, etc., but also information convenient to each client company such as business days and holidays. The operation control definition information 52 includes definition information on the target date and content of the operation control for creating the schedule information 54. The server definition information 53 includes information required for the access to the virtual server system 6 for the client company 2 on the public cloud 30. The contents of the calendar information 51, operation control definition information 52, and server definition information 53 can be properly set to be convenient to each client company 2.

In the operation status information 55, status information indicating at least the current status of the operation control is stored. In the log information 56, information including the series of instructions executed to the virtual server system 6 of the public cloud 30 by the server 10 is stored in time series so as to include the content of the operation status information 55. In the log information 56, note that the information in the case of the occurrence of the error described later is also recorded.

The contents of the schedule information 54, operation status information 55, log information 56, etc., can be referred and confirmed by the setting administrator through a confirmation screen provided by the UI unit 11. The user can confirm a schedule, status, history, etc., of the operation control on the confirmation screen as needed.

Note that, for example, the setting administrator of the service provider 1 and the setting administrator of the service provider 3 may set the above-described setting information in accordance with an instruction made from the setting administrator of the client company 2. For example, the setting administrator of the service provider 1 may previously set a part of the operation control definition information 52 (schedule type, etc., which will be described later). The setting administrator of the client company 2 can select a piece of information from the previously-set definition information and use the selected information for the setting. The setting administrator of the service provider 1 or the service provider 3 may set the information of the public cloud 30 into the server definition information 53.

[Plurality of Public Clouds and Plurality of Virtual Server Systems]

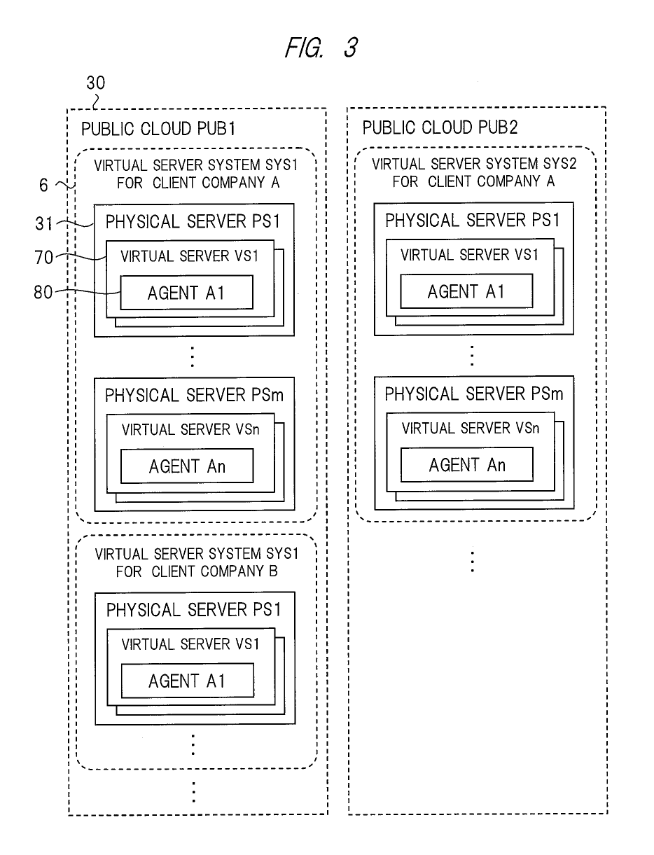

FIG. 3 illustrates an example of virtual server systems 6 of a plurality of client companies 2 in a plurality of public clouds 30. For example, a first public cloud PUB1 and a second public cloud PUB2 are exemplified. For example, a first client company A and a second client company B are exemplified. The client company A uses, for example, a first virtual server system SYS1 operated on the first public cloud PUB1 and a second virtual server system SYS2 operated on the second public cloud PUB2. The client company B uses, for example, the first virtual server system SYS1 operated on the first public cloud PUB1.

The first virtual server system SYS1 for the client company A is composed of “n” virtual servers 70 {VS1 to VSn} configured on “m” physical servers 31 {PS1 to PSm}. The n virtual servers 70 {VS1 to VSn} have a one-to-one correspondence with, for example, agents 80 {A1 to An}, respectively. The same goes for the second virtual server system SYS2 of the public cloud PUB2. The reference characters “PUB1”, “SYS1”, etc., represent identification information for the explanation. The numerals “m”, “n”, etc., represent variable numbers.

The client company 2 can use the virtual server systems 6 of a plurality of desired public clouds 30 in accordance with each calendar of, for example, different departments, etc. The client company 2 can also use a plurality of different virtual server systems 6 in one public cloud 30. As the processes achieved by the information system of the client company 2 using the virtual server systems 6, the company's task process, data backup process, etc., can be cited.

[Configuration Example of Virtual Server System of Client Company]

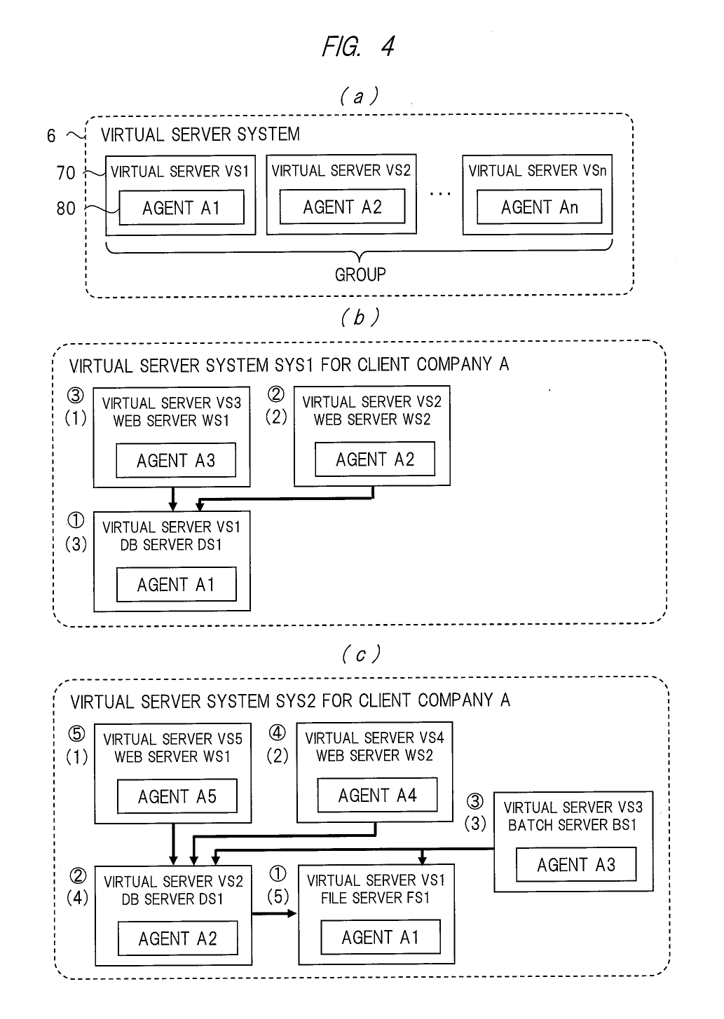

FIG. 4 illustrates a configuration example of the virtual server system 6 for the client company 2. FIG. 4A illustrates a configuration of an aggregation or a group of the plurality of (n) virtual servers 70 {VS1 to VSn} equivalent to the virtual server system SYS1 for the client company A.

FIG. 4B illustrates a first detailed configuration example of the virtual server system SYS1 of the client company A. The virtual server system SYS1 is composed of a DB server DS1 which is a first virtual server VS1, a Web server WS2 which is a second virtual server VS2, and a Web server WS1 which is a third virtual server VS3. The reference characters “VS1”, “DS1”, etc., represent identification information. In a relation among the plurality of virtual servers 70, for example, the Web servers WS1 and WS2 access the DB server DS1 to read/write data. In FIG. 45, the encircled numerals represent activation orders which will be described later, and the parenthesized numerals represent stoppage orders which will be described later.

FIG. 4C illustrates a second detailed configuration example of the virtual server system SYS2 of the client company A. The virtual server system SYS2 is composed of a file server FS1 which is the first virtual server VS1, a DB server DS1 which is the second virtual server VS2, a batch server BS1 which is a third virtual server VS3, a Web server WS2 which is a fourth virtual server VS4, and a Web server WS1 which is a fifth virtual server VS5. In a relation among them, for example, the DB server DS1 accesses the file server FS1, the batch server BS1 accesses the DB server DS1 and the file server FS1, and the Web servers WS1 and WS2 access the DB server DS1.

[Processing Outline]

An outline of processing by the virtual server operation control system of FIG. 2 will be described below.

(1) The user who is the setting administrator of the client company 2 accesses the server 10 through the terminal 41, and properly enters and sets the necessary information such as the calendar information 51, operation control definition information 52, and server definition information 53 of the client company 2 on the setting screen provided by the UI unit 11. The setting contents can be updated as needed.

(2) The schedule creating unit 12 of the server 10 refers to the set information of the above-described item (1) at a predetermined timing based on the setting, and performs a process of creating the schedule information 59, e.g., a time-based instance such as the next day, next week, etc., for controlling the operation of the virtual server system 6 of the client company 2 based on the set information.

The operation control unit 13 of the server 10 refers to the schedule information 54, and executes the control for the activation/stoppage operation of each virtual server 70 of the virtual server system 6 of the target public cloud 30 on the date, the time, and the content described in the schedule information 54. At this time, the operation control unit 13 makes an instruction of the activation to the target public cloud 30 through the API. The operation control unit 13 writes the status information indicating the operation control instruction, etc., into the operation status information 55 as needed, and confirms the status information such as the notification written by the agent 80.

(4) The public cloud 30 activates or stops the virtual server 70 of the virtual server system 6 in accordance with the instruction from the server 10. The agent 80 of the virtual server 70 periodically refers to the operation status information 55 through the agent communication IF unit 16 of the server 10. When the operation control instruction is made by the operation control unit 13, the agent 80 follows the instruction and executes a process of controlling the operation of the virtual server 70, and transmits a notification of completion of the process to the operation control unit 13 to write the status information into the operation status information 55.

(5) Into the log information 56, the operation control unit 13 of the server 10 records a series of information including the above-described operation control instruction, the confirmation result from the public cloud 30, and the notification from the agent 80. In the occurrence of the error described later, the operation control unit 13 records the error information into the log information 56. Based on the setting, the agent 80 and operation control unit 13 notify the user terminal 41 of the error information.

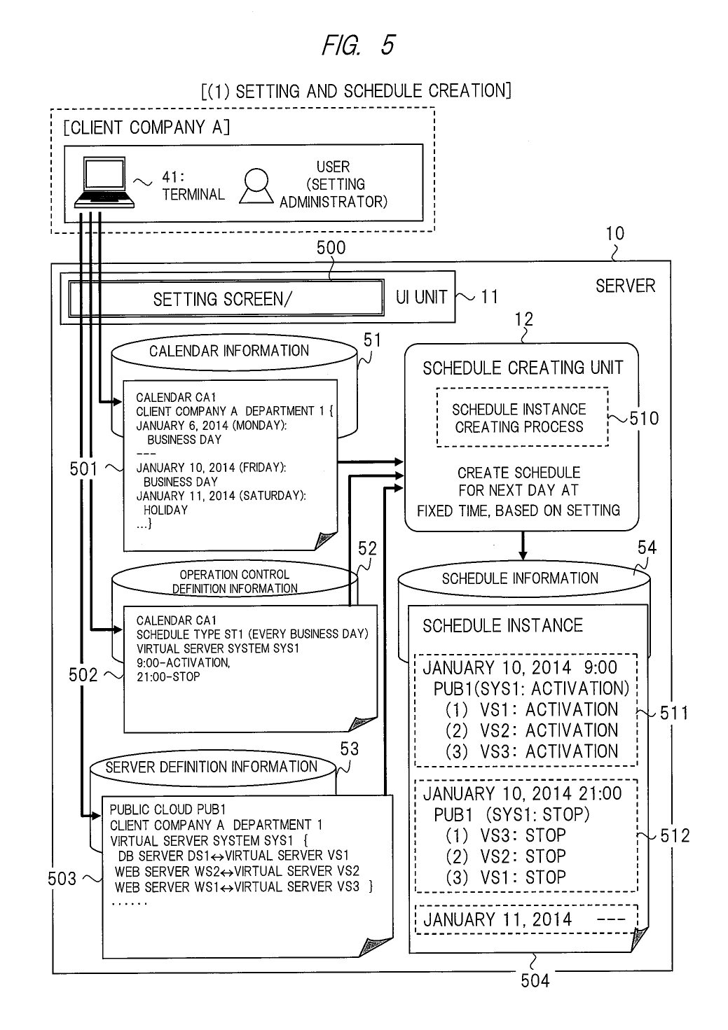

With reference to FIGS. 5 to 8, processes and data made by the virtual server operation control system will be sequentially described below while citing specific examples.

[(1) Setting and Schedule Creation]

FIG. 5 illustrates an example of processes executed in setting and schedule creation. For example, the user who is the setting administrator of the client company A accesses the server 10 through the terminal 41, and sets the contents of the calendar information 51, operation control definition information 52, and server definition information 53 on a setting screen 500 provided by the UI unit 11.

In the calendar information 51, as shown in, for example, 501, a business day, holiday, etc., are set for each calendar date as a calendar CA1 supporting the “department 1” of the client company A. In an implementation, only the holiday information may be registered. In the server definition information 53, as shown in for example, 503, a configuration of the virtual server system SYS1 of the public cloud PUB1 (FIG. 4B) used to support the “department 1” of the client company A is set. Thus, the specific configuration of the virtual server system SYS1 is defined as the plurality of virtual servers 70 {VS1, VS2, and VS3} correlated respectively with the plurality of servers {DS1, WS1, and WS2} seen from the client company 2.

In the operation control definition information 52, for example, definition information of the target calendar, virtual server system, execution date and time, operation control action, etc., are set. In the definition information, as shown in, for example, 502, the target calendar CA1, a schedule type ST1 which specifies an execution target date in the calendar CA1, the target virtual server system SYS1, and the operation control action are set. The operation control action is set so that, for example, the activation is at 09:00 and the stoppage is at 21:00 (9 p.m.). Although described later, the schedule type ST1 specifies “every business day”, that is, specifies that operation control is executed every business day (every day except for the holidays) here.

Based on the contents of the setting information of the calendar information 51, operation control definition information 52, and server definition information 53, the schedule creating unit 12 creates a schedule instance for the operation control at a predetermined timing based on the setting, and stores the schedule instance in the schedule information 54. Based on variable setting by the setting administrator of each client company 2, the schedule creating unit 12 creates a predetermined time-based schedule instance such as a schedule instance for the next day, at a fixed time such as 22:00 on every day.

As shown in, for example, 504, the schedule instances include information of the target public cloud 30, the plurality of virtual servers 70 of the virtual server system 6, the operation control actions, etc., in a time-series order of operation control execution dates. This information includes information of an order of the activation/stoppage of each of the plurality of virtual servers 70. In the schedule instances 504, note that activation/stop action information based on the virtual server system 6 is indicated with parentheses. However, in implementation, the information based on the virtual server system 6 can be omitted.

In the schedule instances 504, for example, a reference character 511 indicates an instruction to activate the virtual server system SYS1 of the public cloud PUB1 at 9:00 on January 10 in an order of {VS1, VS2, and VS3}. A reference character 512 indicates an instruction to stop the virtual server system SYS1 of the public cloud PUB1 at 21:00 on January 10 in an order of {VS3, VS2, and VS1}.

[(2) Execution of Virtual Server Operation Control]

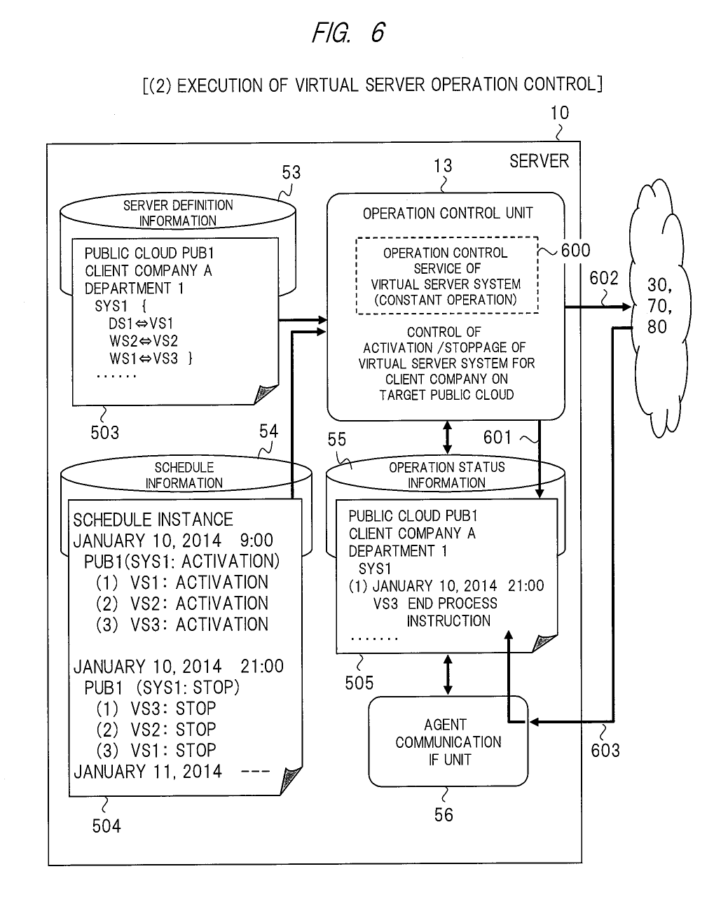

Subsequently, FIG. 6 illustrates an example of processes, etc., in execution of the operation control. The contents of the server definition information 53 and schedule information 54 are the same as those in FIG. 5. The operation control unit 13 constantly operates an operation control service 600 for the virtual server system 6. The operation control service 600 of the operation control unit 13 controls the activation/stoppage of the plurality of virtual servers 70 of the virtual server system 6 for the client company 2 in the target public cloud 30 on the date, time, and contents based on the schedule instances of the schedule information 54, while using the information (including authentication information described later) of the server definition information 53. In order to exchange data with the agent 80, the operation control service 600 of the operation control unit 13 writes the status information such as the instruction to the operation status information 55 as needed as shown in 505.

A reference character 601 indicates that the operation control unit 13 writes the status information such as the end process instruction into the operation status information 55. A reference character 602 indicates that the operation control unit 13 transmits the activation/stop instruction to the public cloud 30 through the API. A reference character 603 indicates that the agent 80 of the virtual server 70 makes polling access, i.e., periodically refers to the operation status information 56 via the agent communication IF unit 16 of the server 10.

[(3) Processes in Activation of Virtual Server System]

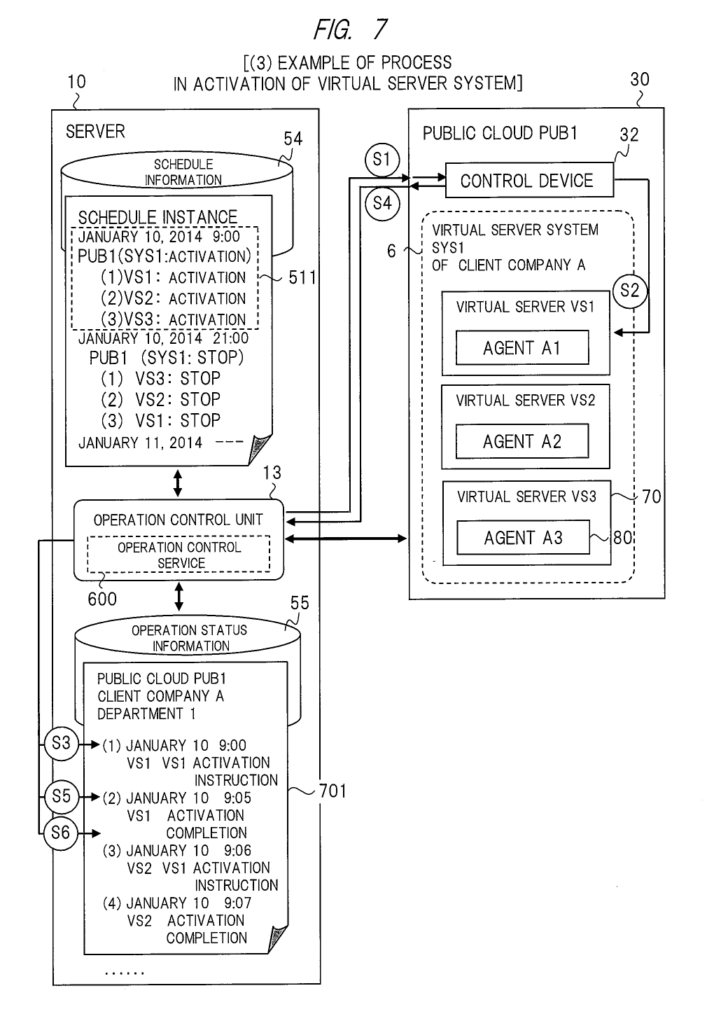

FIG. 7 illustrates an example of processes in the activation of the virtual server system 6. The operation control unit 13 of the server 10 or others perform processes of steps S1 to S6 illustrated in FIG. 7 in this order. In accordance with the schedule information 59, the operation control service 600 of the operation control unit 13 activates the plurality of virtual servers 70 of the virtual server system 6 of the target public cloud 30 in a predetermined order. The following is an explanation about an example of the activation of the virtual servers VS1 to VS3 of the virtual server system SYS1 in accordance with the information of the schedule instance 511 in the order of {VS1, VS2, and VS3}.

(S1) In accordance with the information of the schedule instance 511, first, the operation control unit 13 of the server 10 transmits the activation instruction aiming at the virtual server VS1 which is the first virtual server 70 in the virtual server system SYS1 of the client company A, to the target public cloud PUB1 through the API.

(S2) The public cloud PUB1 which has received the activation instruction of step S1 causes the management device 32 to activate the virtual server VS1 of the target virtual server system SYS1 and the agent A1 corresponding to the virtual server VS1. The agent A1 is activated by the OS of the virtual server VS1.

(S3) The operation control unit 13 writes the status information indicating the activation instruction into the operation status information 55 so as to correspond to the issue of the activation instruction of step S1. The status information is shown in 701 as “(1) January 10, 9:00, VS1, activation instruction”.

(S4) The operation control unit 13 confirms the completion of the activation of the virtual server VS1 through the public cloud PUB1. Through the management device 32, the public cloud PUB1 replies a notification of the activation completion of the virtual server VS1 to the operation control unit 13 of the server 10.

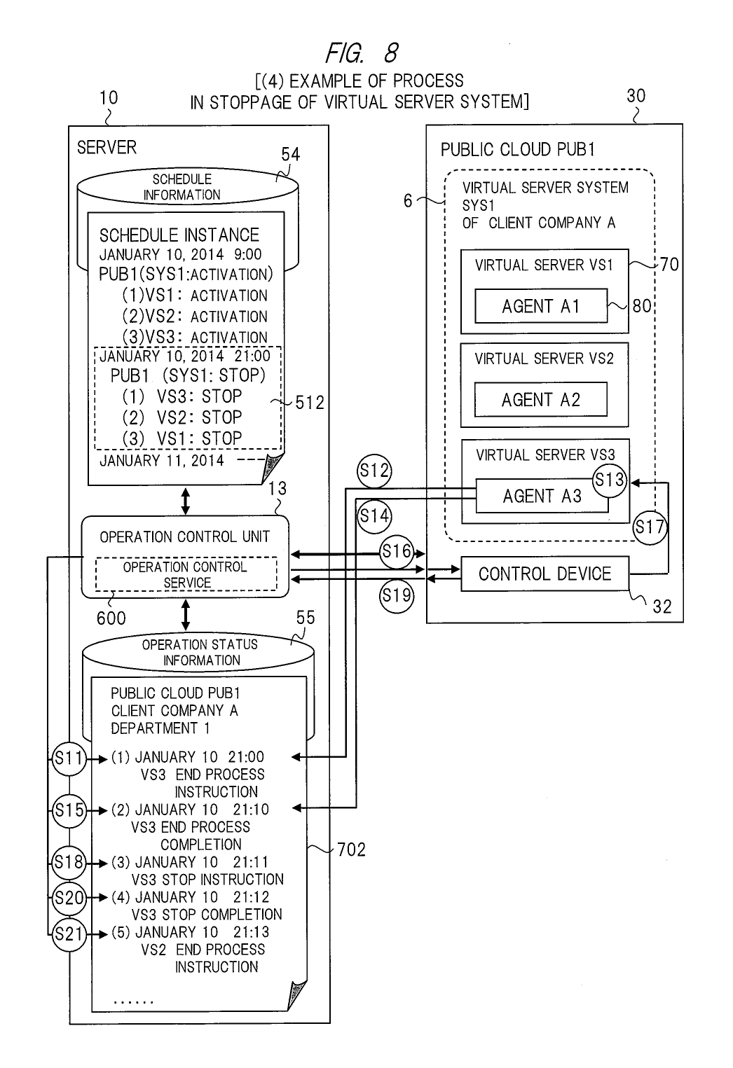

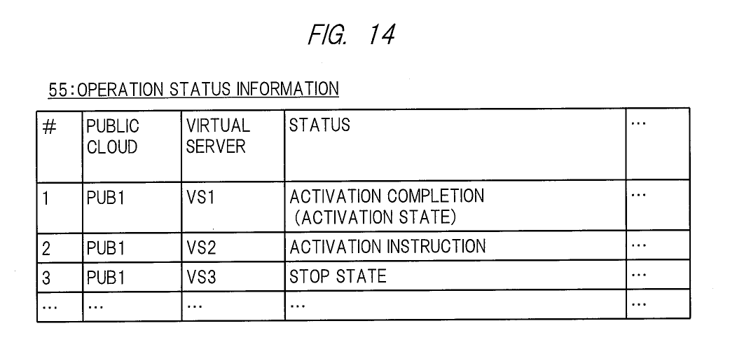

(S5) The operation control unit 13 receives the notification of step S4, and then, writes the status information indicating the activation completion of the virtual server VS1 into the operation status information 55. This status information is shown as “ . . . VS1 activation completion”. Although described later (FIG. 14), the current status is written and stored for each virtual server 70 in the operation status information 55. In the status information 701 of the operation status information 55 in FIG. 7 (as well as the status information 702 in FIG. 8), note that a change history of the statuses of the target virtual server 70 is written in a time-series order for facilitating understanding of the description.

(S6) The operation control unit 13 proceeds to a process for the virtual server VS2 which is the virtual server 70 to be supposed to be activated next. The activation processes for the virtual server VS2 are repeated as similar to the above-described steps S1 to S5. The corresponding status information is shown as “ . . . VS2, activation instruction” and “ . . . VS2, activation completion”. After the process for the virtual server VS2, an activation process for the virtual server VS3 is similarly performed. In this manner, the server 10 sequentially activates the virtual servers 70 {VS1 to VS3} of the virtual server system SYS1. The operation control unit 13 records the status of a series of processes executed at steps S1 to S6, in the log information 56.

[(4) Processes in Stoppage of Virtual Server System]

FIG. 8 illustrates an example of processes in the stoppage of the virtual server system 6. The operation control unit 13 of the server 10, the agent 80 of the public cloud 30, and others execute steps S11 to S21 shown in FIG. 8 in this order. In accordance with the schedule information 54, the operation control service 600 of the operation control unit 13 stops the plurality of virtual servers 70 of the virtual server system 6 of the target public cloud 30 in a predetermined order. The following is an explanation about an example of stopping the virtual servers VS1 to VS3 of the virtual server system SYS1 in the order of {VS3, VS2, and VS1} in accordance with the information of 512.

(S11) Into the operation status information 55, the operation control unit 13 writes the status information for making an end process instruction to stop the virtual server VS3 that is the third virtual server 70 of the virtual server system SYS1 of the client company A in the target public cloud PUB1 in accordance with the information of 512. In 702, this status information is shown as “(1) January 10, 21:00, VS3, end process instruction”.

(S12) An agent A3 that is the agent 80 periodically refers to the operation status information 55 so as to confirm the end process instruction of the above-described step S11.

(S13) In accordance with the above-described end process instruction, the agent A3 executes a predetermined end process for stopping the virtual server VS3. This end process is a process in consideration of characteristics of and limitations of the public cloud PUB1, which is, for example, a process of previously ending a process that cannot be ended within the above-described end time limit of the OS of the virtual server VS3.

(S14) When completing the end process, the agent A3 transmits a notification of completion of the end process to write the corresponding status information into the operation status information 55 through the agent communication IF unit 16. The status information is shown as “ . . . VS3, end process completion”.

(S15) The operation control unit 13 confirms the status information of the end process completion in the step S14 in the operation status information 55.

(S16) Based on the confirmation at step S15, the operation control unit 13 transmits an instruction to stop the virtual server VS3 of the virtual server system SYS1 to the public cloud PUB1 through the API.

(S17) The public cloud PUB1 receives the stop instruction of step S16, and causes the management device 32 to stop the virtual server VS3 of the virtual server system SYS1 and the corresponding agent A3. The agent A3 is stopped by using the OS of the virtual server VS3.

(S18) The operation control unit 13 issues the stop instruction at step S16, and then, writes the corresponding status information into the operation status information 55. This status information is shown as “ . . . VS3, stop instruction”.

(S19) The operation control unit 13 confirms the public cloud PUB1 through the API regarding the status of the virtual server VS3 of the virtual server system SYS1, and repeatedly confirms it until the status is the stop status.

(S20) The operation control unit 13 confirms the stop completion status at step S19, and then, writes the status information indicating the completion of stop of the virtual server VS3 into the operation status information 55. This status information is shown as “ . . . VS3, stop completion”.

(S21) The operation control unit 13 proceeds to a process for the virtual server VS2, which is the virtual server 70 supposed to be stopped next. The processes of activating the virtual server VS2 are repeated as similar to the steps S11 to S20 as described above. After the process for the virtual server VS2, a process of stopping the virtual server VS3 is similarly performed. In this manner, the server 10 sequentially stops the virtual servers 70 {VS1 to VS3} of the virtual server system SYS1. The operation control unit 13 records the status of a series of processes executed at steps S11 to S21, in the log information 56.

[Case of Error in Activation or Stoppage]

In the present system, during the control for the activation/stoppage of the virtual server 70 among the operation control unit 13 of the server 10, the public cloud 30 and agent 80, a case incapable of completing the activation/stoppage may occur for any reason. When the process of activating or stopping the virtual server 70 is not completed normally, the server 10 or the agent 80 determines that this status is an exceptional error or an anomalous status as the process. The above-described reason is, for example, a communication failure on the Internet 4, a failure of the physical server 31, etc.

The above-described error or anomalous status is roughly classified into the following three types. The server 10 and the agent 80, for example, determines the error, etc., and performs a process for dealing with the error, etc., as follows.

(1) One type is communication error, authentication error, etc., occurring when the operation control unit 13 communicates with the public cloud 30. For example, the stop completion may not be confirmed even after an elapse of a predetermined time although the operation control unit 13 has transmitted the stop instruction to the public cloud 30, or an authentication result may be error although authentication information has been transmitted in the access. When the operation control unit 13 detects this status, the operation control unit 13 determines that this status is error and deals with this status. The operation control unit 13 records information of the error in the log information 56.

(2) After the operation control unit 13 instructs the agent 80 to perform the end process through the operation status information 55, the operation control unit 13 waits for a notification of completion of the end process from the agent 80. If time is up for the waiting, that is, if the status information of the completion cannot be confirmed even when the waiting time exceeds a preset upper limit, the operation control unit 13 determines this status as the above-described error and deals with it. The operation control unit 13 records information of the error in the log information 56.

(3) While the agent 80 starts the end process for the stoppage after receiving the instruction, an unexpected failure may occur in the physical server 31, etc., during the end process, and therefore, the end process cannot be completed. When detecting such a failure, the agent 80 determines that this status is the above-described error and deals with it. The agent 80 notifies the server 10 of the error information, and causes the server 10 to write the error information into the operation status information 55. The operation control unit 13 recognizes the status information of the error and records the status information in the log information 56.

In the occurrence of the errors (1) to (3), the operation control unit 13 may notifies the user's terminal 41 of the error information based on the user setting by e-mail, etc. In the occurrence of the error (3), the agent 80 may directly notify the user's terminal 41 of the error information based on the user setting. The user can recognize and confirm the contents of the error by viewing the log information 56 on a screen of the terminal 41 or by the above-described notification of the error information. In accordance with the operation, the user may deal with the error immediately after receiving the notification or deal with it later while referring to the log information 56.

As a function of notifying the user's terminal 41 of the above-described error, it can be set whether or not the user's terminal is notified of the error, or a determination address for the notification, etc., can be set, by the setting administrator on a setting screen of the UI unit 11.

[(a1) Calendar Information and Setting Screen of Client Company]

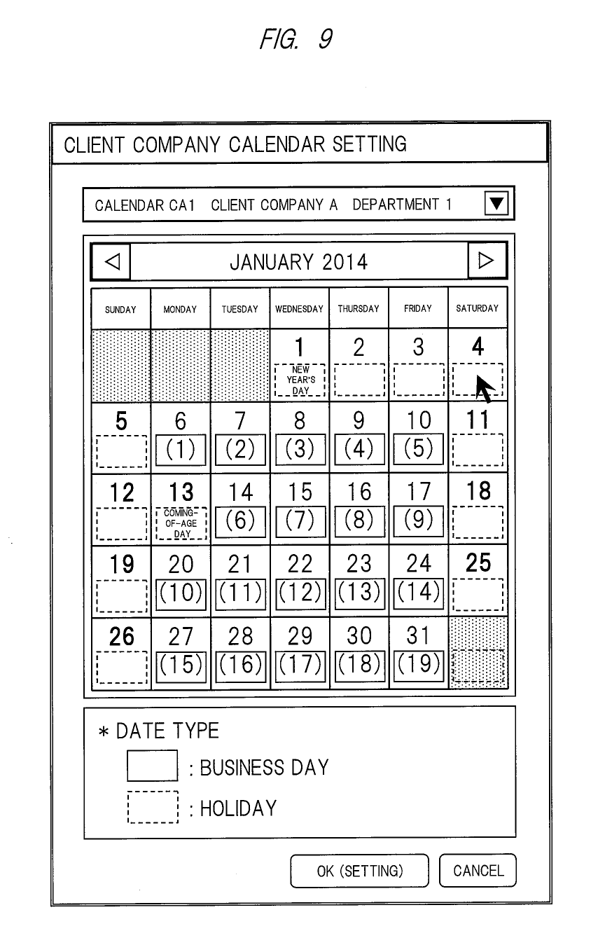

FIG. 9 illustrates an example of a setting screen of the calendar information 51 of the client company. The setting administrator can set a plurality of calendars corresponding to departments of the client company 2, etc., on the present screen, and can use the plurality of calendars depending on cases. The information set on the present screen is stored in the calendar information 51.

The example of the calendars of the client companies on the setting screen of FIG. 9 has a form in which the information of business days, holidays, etc. which are the characteristics of each client company 2 is registered onto an ordinary calendar as information of a unique date type of the present system. In the present example, the date type has two items which are the business day (first date type) and the holiday (second date type). On the present screen, the user can select desired calendar days and the period of the selected calendar days (year, month, date, day of week, etc.) and select and register the business day, the holiday, etc., which is the date type registered on the calendar days.

A method of setting a date type on the screen can be various. In the present example, the user can switch the business day and the holiday by operating the selection and the clicking of the calendar day and others on the screen. As a default setting in an implementation method, all calendar days are automatically set to be the business days, and a date supposed to be the holiday among the calendar days is selected and registered by the user.

The example of the calendar of FIG. 9 shows January of 2014 as the calendar CA1 for the “department 1” of the client company A. In the calendar days (first to 31^{st} of January), numbers with round parentheses indicate the business days. Squares drawn by continuous lines indicate the business days, while squares drawn by broken lines indicate the holidays. For example, January 6 is the first business day, and 31^{st} of January is the 19th business day. 1^{st} of January, 13^{th} of January, etc., are the holidays of the calendar days. The calendar form is not limited to the weekly calendar form shown in FIG. 9.

The user can set a calendar for each client company 2 by performing such a simple operation as selecting the business day or the holiday on the present setting screen. In a different setting method, the screen is provided with an item for selecting a registration target date for each date type from options and setting the selected target date as an item for collectively registering the date type for a plurality of dates. For example, in the item for setting the target registration date as “holiday”, “Every Sunday in Month” and “Every Saturday, Sunday, and Public Holiday in Month” as the options.

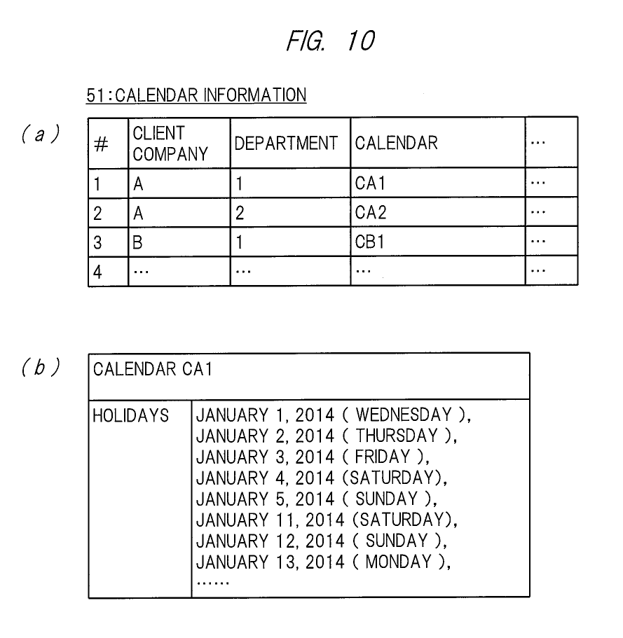

FIG. 10 illustrates a table representing a configuration example of the calendar information 51. In FIG. 10, a table of (a) on an upper side of the calendar information 51 includes a client company, a department, and a calendar as the items. In this setting example, a “department 1” of a client company A uses the calendar CA1, a “department 2” of the same uses a calendar CA2, and a “department 1” of a client company B uses a calendar CB1.

In FIG. 10, a table of (b) on a lower side of the calendar information 51 represents an example of the setting contents of the calendar CA1, and corresponds to the setting example of FIG. 9. In the item which is the date of the holiday in this table, dates (year, month, date, day of week) registered as the date type of the holiday are stored. From this setting information, it is understood that the date type of other dates is the business day.

As the setting for the calendar information 51, a table as illustrated in FIG. 10 may be displayed on the setting screen, and values may be entered in the items of the table. If client company calendar information is already presented, the information can be used directly as the calendar information 51, so that the setting work can be omitted.

[(a2) Operation Control Definition Information]

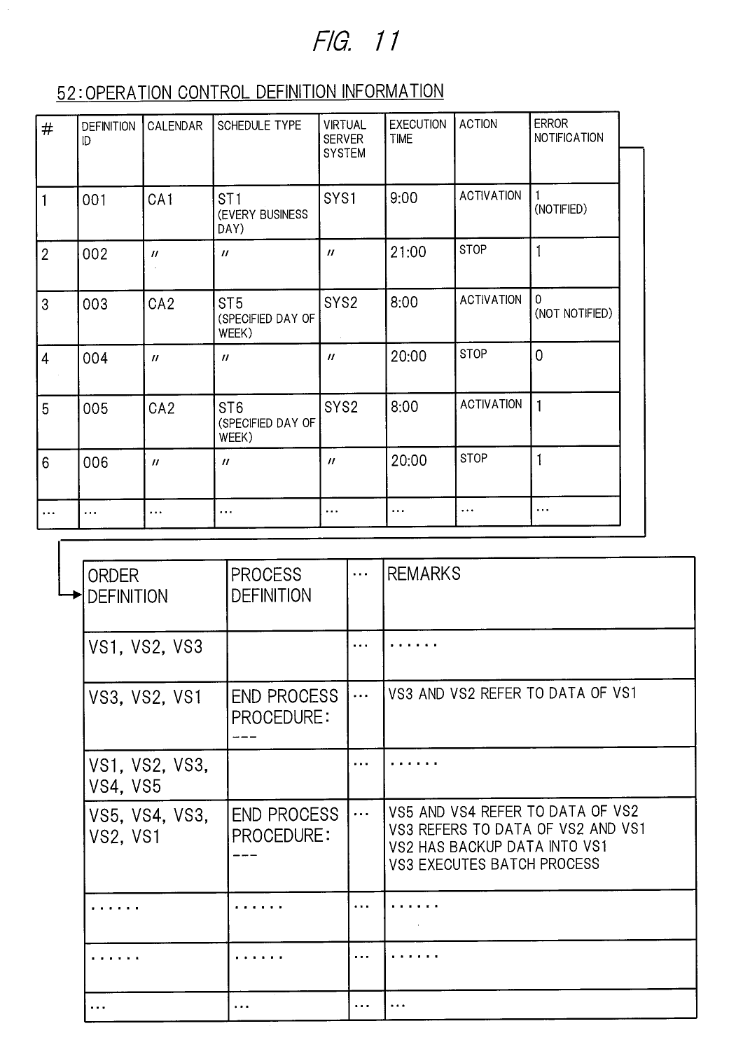

FIG. 11 illustrates a table representing a configuration example of the operation control definition information 52. In the operation control definition information 52, information of operation control execution target dates, operation control actions, etc., applied to a calendar of the target client company is set so as to correspond thereto as the definition information for creating an operation control schedule. In the present embodiment, the operation control definition information 52 can be set by a simple operation using a schedule type, etc. Based on the schedule type, an operation control execution day can be specified in a period of the calendar days.

The table of the operation control definition information 52 of FIG. 11 includes a definition ID, a calendar, a schedule type, a virtual server system, an execution time, an action, an error notification, an order definition, a process definition, and remarks as the items. In the item of the definition ID, identification information for the definition information is stored. In the item of the calendar, an ID of the calendar defined by the calendar information 51 is stored.

In the item of the schedule type, a schedule type applied to the target calendar is stored. The schedule type is information used for specifying a schedule including an operation control execution day during a period of the target calendar days. In other words, the schedule type is information used for specifying a schedule type or a method of selecting the execution target day.

In the item of the virtual server system, an ID of the virtual server system 6 defined by the server definition information 53 or IDs of a plurality of virtual servers 70 making up the virtual server system 6 is stored. In implementation, note that the ID of the virtual server system 6 can be omitted.

In the item of the execution time item, time information indicating target hour, minute, etc., on time at which the operation control action is executed is stored. In the present example, note that the schedule type is the information used for specifying the execution target day, and therefore, the execution time is specified in a different item.

In the item of the action, information indicating the operation control action, in other words, values of “activation” and “stop” are stored. In the item of the error notification, a value indicating whether the above-described error notification is issued or not is stored. In the item of the order definition, definition information indicating the activation sequential order or the stop sequential order among the plurality of virtual servers 70 in the operation of the target virtual server system 6 is stored. In the item of the process definition, definition information indicating a specific process that is needed in the activation or stop action is stored. This definition information includes, for example, information used for issuing an instruction of an end process procedure for the stop action in accordance with the above-described characteristics of and limitations of the public cloud 30. The item of the remarks is remarks information that is optional for the setting administrator. In the present example, a note for a relation among the plurality of virtual servers 70 (FIG. 4) are shown.

In lines #1 and #2 in the setting example of the operation control definition information 52 of FIG. 11, the schedule type ST1 (every business day), the virtual server system SYS1, and the error notified, etc., are set as the “definition IDs=001 and 002” for the calendar CA1 corresponding to the “department 1” of the client company A. A reference character “ST1” indicates that the above-described business day (first date type) is set to be the execution target day. The “definition ID=001” in the line #1 indicates that the virtual servers {VS1, VS2, and VS3} of the SYS1 are activated in this order at 09:00 that is the execution time on the business day. The “definition ID=002” in the line #2 indicates that the virtual servers {VS1, VS2, and VS3} of the SYS1 are stopped in this order of {VS3, VS2, and VS1} at 21:00 on the business day.

The definition information of “definition IDs=001 and 002” is, in other words, equivalent to a state in which the activation status is maintained in a period of time from 09:00 to 21:00 on the business day and a state in which the stop status is maintained in periods of time from 00:00 to 09:00 and from 21:00 to 24:00.

In lines #3 and #4, the schedule type ST5 (day of week specified) described later, the virtual server system SYS2, and the error not notified, etc., are set as the “definition IDs=003 and 004” for the calendar CA2 corresponding to the “department 2” of the client company A. A reference character “ST5” indicates that the above-described specified days of week (for example, Monday and Thursday) are set to be the execution target days. The line #3 indicates that the virtual servers {VS1, VS2, VS3, VS4, and VS5} of the SYS2 are activated in this order at 08:00 on the specified day of week. The line #4 indicates that the virtual servers {VS5, VS4, VS3, VS2, and VS1} of the SYS2 are stopped in this order at 20:00 on the specified day of week.

Similarly, in lines #5 and #6, the different schedule type ST6 (day of week specified), the virtual server system SYS2, and the error notified, etc., are set as the “definition IDs=005 and 006” for the same calendar CA2. A reference character “ST6” indicates that the specified day of week (for example, Saturday) is set to be the execution target day.

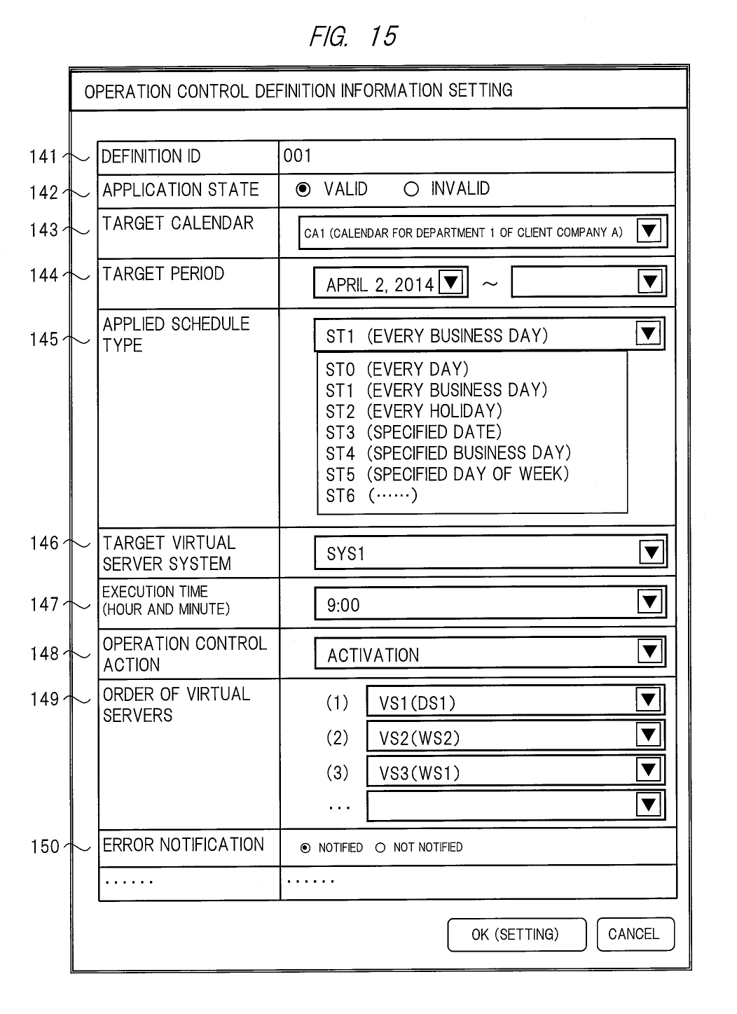

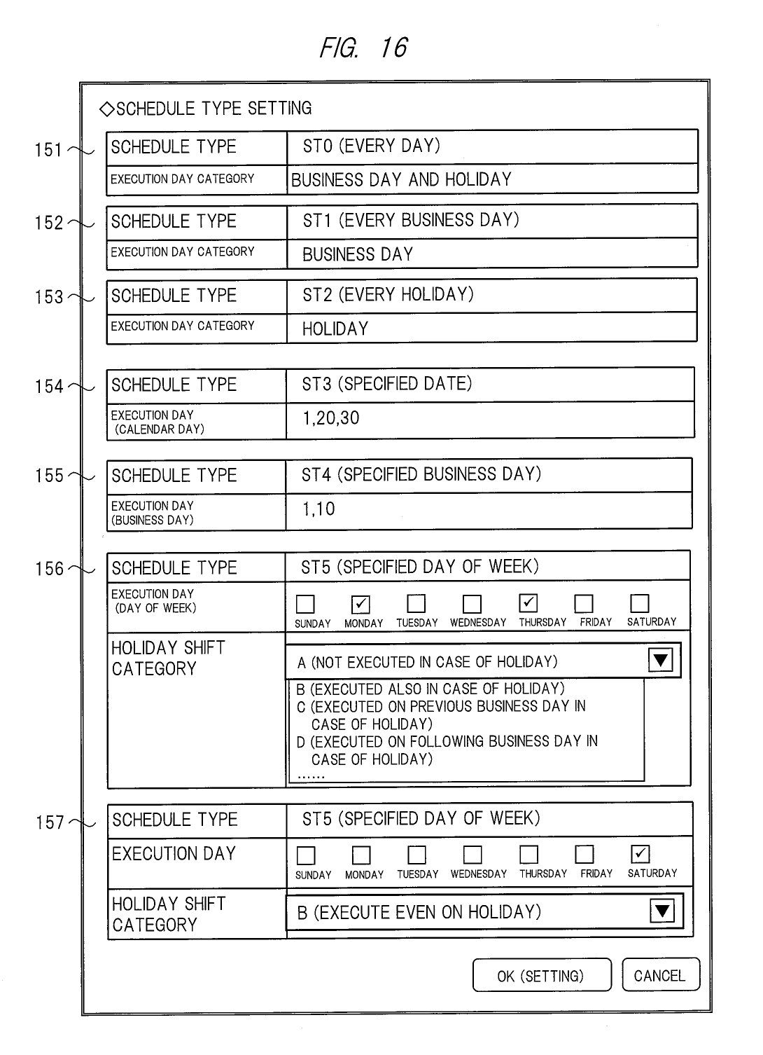

On the setting screen as shown in FIGS. 15 and 16 described later, the user can set the operation control definition information 52 including the schedule type. The setting of the operation control definition information 52 may have a mode in which the table as in FIG. 11 is displayed on a setting screen and in which values are entered in items. The user can similarly set a plurality of pieces of necessary definition information in accordance with the convenience of the client company 2. In the present system, a setting patterns of the definition information may be previously prepared, and the user may select and use one of the setting patterns on the setting screen.

[(a3) Server Definition Information]

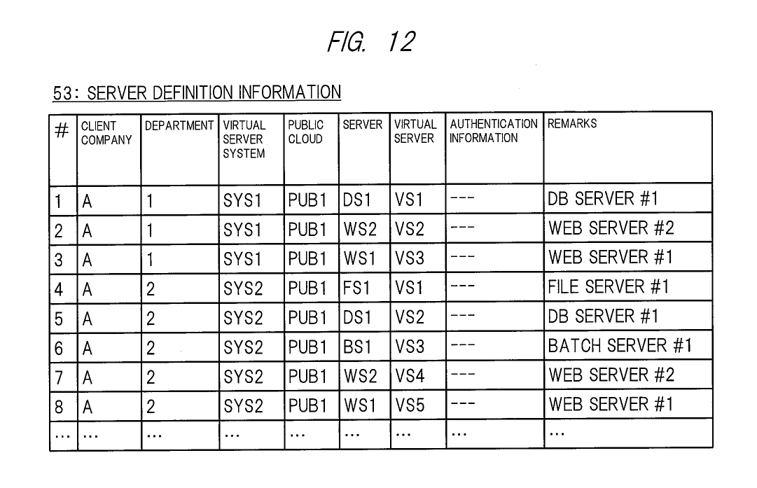

FIG. 12 illustrates a table indicating a configuration example of the server definition information 53. In the server definition information 53, the information of the virtual server system 6 of the client company 2 and the information of the public cloud 30 are managed so as to correspond to each other. The table of the server definition information 53 of FIG. 12 includes a client company, a department, a virtual server system, a public cloud, a server, a virtual server, authentication information, and remarks as the items.

In each item of the client company, the department, the virtual server system, the public cloud, the server, and the virtual server, each ID, etc., is stored. The item of the virtual server system can be omitted in implementation. In the present system, the virtual server system 6 is composed of only one virtual server 70 in some cases. In such a case, information of the one virtual server 70 is set. In the item of the server, information of a unit of the servers seen from the client company 2 is set. For example, information of the Web server WS1, DB server DS1, etc., in FIG. 4 described above is set. In the item of the virtual server, information of a unit of the virtual servers 70 in the public cloud 30 is set so as to correspond to the servers in the item of the server.

In the item of the authentication information, information of the API calling which is used in the access and the control instruction to the public cloud 30 and the authentication information such as an ID or a password which is required for the authentication process are stored. The server 10 of the present system accesses the public cloud 30 using the authentication information, but does not directly access to the virtual server 70. The item of the remarks represents a note for detailed information of the server in the present example as the remarks information that is optional for the setting administrator.

On the setting screen, the user performs the setting by entering values into the items of the table of the server definition information 53. In the server definition information 53, etc., note that information of the agent 80 may be corresponded to information of the virtual server 70. The agent 80 stores information of the virtual server 70 that is the target for the agent 80 itself and information for communication with the server 10 as the setting information.

[(a4) Schedule Information]

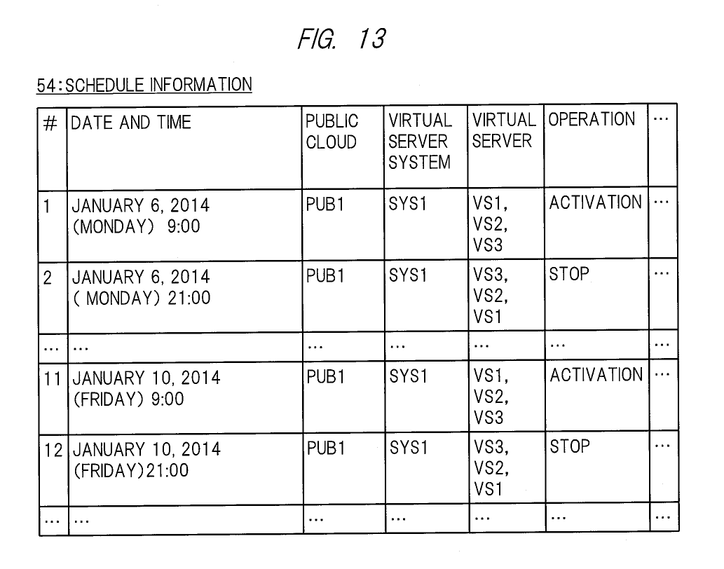

FIG. 13 illustrates a table indicating a configuration example of the schedule information 54. The table of the schedule information 54 of FIG. 13 includes date and time, a public cloud, a virtual server system, a virtual server, and an action as the items.

In the item of the date and time, year, month, date, and time at which the execution of the operation control action is started on the plurality of virtual servers 70 of the virtual server system 6 are stored. In the items of the public cloud, the virtual server system, and the virtual server, each ID, etc., is stored. By the ID of each of these items or others, such information as the authentication information of the server definition information 53 can be referred. Note that the authentication information or others may be stored in the schedule information 54. The item of the virtual server system may be omitted in implementation. In the item of the action, a value of the “activation” or “stop”, etc., is stored as similar to the item of the action in FIG. 11.

In the line of the schedule information 54, an instruction of the action for the plurality of virtual servers 70 in a predetermined order is stored. In the setting example of the schedule information 54 of FIG. 13, the first line indicates an instruction to sequentially activate the virtual servers VS1 to VS3 of the virtual server system SYS1 of the public cloud PUB1 on 6^{th} of January (Monday) at 09:00. Note that the time “9:00” in the item of the date and time indicates the date and time at which the activation instruction is issued in a unit of the virtual server system SYS1. Because the plurality of virtual servers 70 are sequentially activated, a difference is made in the actual activation date and time among the virtual servers 70 depending on situations. Similarly, the second line indicates an instruction to sequentially stop the virtual servers VS3 to VS1 of the virtual server system SYS1 of the public cloud PUB1 on 6^{th} of January (Monday) at 21:00. FIG. 13 illustrates only information about the virtual server system SYS1. When there is information of instructions about other virtual server systems 6, such information is collectively stored in time series.

[(a5) Operation Status Information]

FIG. 14 illustrates a table representing a configuration example of the operation status information 55. The table of the operation status information 55 of FIG. 14 includes a public cloud, a virtual server, and a status as the items. In the present table, the status is written and stored for each virtual server 70. As illustrated in FIGS. 6 and 7, in the item of the status, a status value in accordance with an operation control situation at a moment, such as “activation instruction”, “activation completion (activation status)”, “stop instruction”, “stop completion (stop status)”, “end process instruction”, or “end process completion”, is stored. The example of FIG. 14 shows the status of each virtual server 70 at a moment at which a “activation instruction” is issued to the virtual server VS2 of the public cloud PUB1.

The operation control unit 13 recognizes the status of each virtual server 70 through the operation status information 55. In the present embodiment, note that the example of the sequential activation/stoppage of the plurality of virtual servers 70 has been described. However, in implementation, the plurality of virtual servers 70 may be activated or stopped simultaneously in parallel to each other. For example, a plurality of virtual servers 70 not depending on themselves can be activated or stopped simultaneously in parallel each other. In this case, a processing time can be shortened by the simultaneous processing.

[(a6) Setting Screen of Operation Control Definition Information]

FIGS. 15 and 16 illustrate examples of setting screens for setting the operation control definition information 52. On the present setting screens, the user can set a plurality of schedule types in accordance with the convenience of the client company 2, select a schedule type from the set schedule types, and use it. By the specification of the schedule type, the operation control contents for a plurality of days on a calendar can be collectively specified.

The example of the stetting screen of FIG. 15 includes a definition ID 141, an application state 142, a target calendar 143, a target period 144, an applied schedule type 145, a target virtual server system 146, an execution time 147, an operation control action 148, a virtual server order 149, and an error notification 150 as setting columns.

The definition ID 141 corresponds to the definition ID item of the operation control definition information 52 of FIG. 11. In the application state 142, it can be selected whether or not the application state of the definition information of the definition ID is valid. In the target calendar 143, an applied target calendar can be selected. In the target period 144, a target period (the start date and time, end date and time, etc.) for the target calendar can be selected.

In the 145, a schedule type to be applied to the target period for the target calendar can be selected from, for example, options of a list box, and can be set. The setting for each schedule type will be described later with reference to FIG. 16.

In the target virtual server system 146, a target virtual server system 6 for the operation control can be selected by using an ID, etc. In the execution time 147, an hour and a minute at an execution time for the operation control action can be selected. In the operation control action 148, an activation or a stop action can be selected. In the virtual server order 149, an order of the actions of the plurality of virtual servers 70 of the target virtual server system 6 can be selected. Options in the column of 149 are displayed based on the server definition information 53. In the error notification 150, it can be selected whether or not the error notification described above is issued.

In 145 of the setting example of FIG. 15, the schedule type ST1 (“every business day”) is selected. As a result, all days specified as the business days in a period on or after 2^{nd} of April in the target calendar CA1 can be specified as the execution target days of a predetermined operation control (“activation”).

FIG. 16 illustrates an example of a setting screen for the schedule type. The screen of FIG. 16 includes setting columns 151 to 157 for the schedule type: On the present screen, the user can confirm and set the contents of a plurality of schedule types.

In the column 151, “every day” is set as the schedule type ST0, and “business day and holiday” are set as the execution day category. Note that a reference character “ST0”, etc., represents identification information. By the schedule type ST0, every day is specified as the execution target day, regardless of whether the day is the business day or the holiday. The line for the execution day category shows a category of the execution target day (corresponding to the date type described above). In the column 152, “every business day” is set as the schedule type ST1, “business day” is set as the execution day category, and only the business day is specified as the execution target day. In the column 153, “every holiday” is set as the schedule type ST2, “holiday” is set as the execution day category, and only the holiday is specified as the execution target day.

The schedule types in the columns 151 to 153 show examples of the schedule types previously set by the present system. Not only the schedule types in the columns 151 to 153 but also a schedule type whose execution day category is a different date type can be set.

In the column 154, “specified date” is set as the schedule type ST3, and a specific calendar day is specified as the execution target day. In the line for the execution day, for example, numbers separated by a comma are entered by the user, so that the specific calendar date to be the execution target day can be set. In this setting example, the 1^{st} of a month, 20^{th} of the month, and 30^{th} of the month are specified as the execution days.

In the column 155, “specified business day” is set as the schedule type ST4, and a specific business day is specified as the execution target day. In the line for the execution day, for example, numbers of the business day separated by a comma are entered by the user, so that the specific business day can be set. In this setting example, the 1^{st} business day of a month and 10^{th} business day of the month are the target days.

In the column 156, “specified day of the week” is set as the schedule type ST5, and a specific day of every week is specified as the execution target day. In the line for the execution day, one or more day of week is selected as needed from, for example, check boxes from Sunday to Saturday, so that a specific day of week to be the execution target day can be set. In this setting example, Monday and Thursday are the execution days.

The setting column 156 includes an item of a holiday shift category. In the holiday shift category, a controlling method used when the execution target date (day of week) is the holiday (the second date type described above) can be selected and set by the user. Examples of the holiday shift category include A: Not Executed in case of Holiday, B: Executed also in case of Holiday, C: Executed on Previous Business Day in case of Holiday, D: Executed on Next Business Day in case of Holiday, and others. In the categories C and D, the execution target day and action are shifted. In the category C, the control action is executed on an immediately previous business day. In the category D, the control action is executed on an immediately following business day. Further, in the holiday shift category, it can be set whether or not a date shifted from an initial setting date has to stand over a month end of the initial setting date although not illustrated as needed. If “the date does not have to stand over the month end”, the date shifted from the initial setting date is set so as not stand over the month end, and, if there is no appropriate day in the month, no execution of the control action is set. If “the date has to stand over the month end”, the date shifted from the initial setting date can stand over the month end, and, if there is no appropriate day in the month, execution of the control action in a previous month or on a following date is set. Also for other schedule types such as the schedule type ST3, note that a shift category can be set as similar to the case of the schedule type ST5.

In the category 157, a different setting example of the “specified day of the week” is set as the schedule type ST5, Saturday is set as the execution day, and “B” (executed also in case of holiday) is set as the holiday shift category. Even for the same schedule type, a plurality of different setting contents may be set and used by naming each of them.

In the item of the schedule type in 145 on the screen of FIG. 15, options for a plurality of choices of schedule types based on the schedule type setting on the screen of FIG. 16 are displayed. The schedule type setting is not limited to the above-described example, and various schedule types can be set. As examples of the schedule type, “specified month” and “specified week”, etc., are cited.

On the screens of FIGS. 15 and 16, the user can set the operation control definition information 52 by performing a simple operation of specifying the schedule type, etc. This manner can achieve various operation controls convenient to the client company 2 which include scheduling in accordance with determination on a date condition such as the holiday shift.

[(a7) Operation Control Schedule Confirmation Screen]

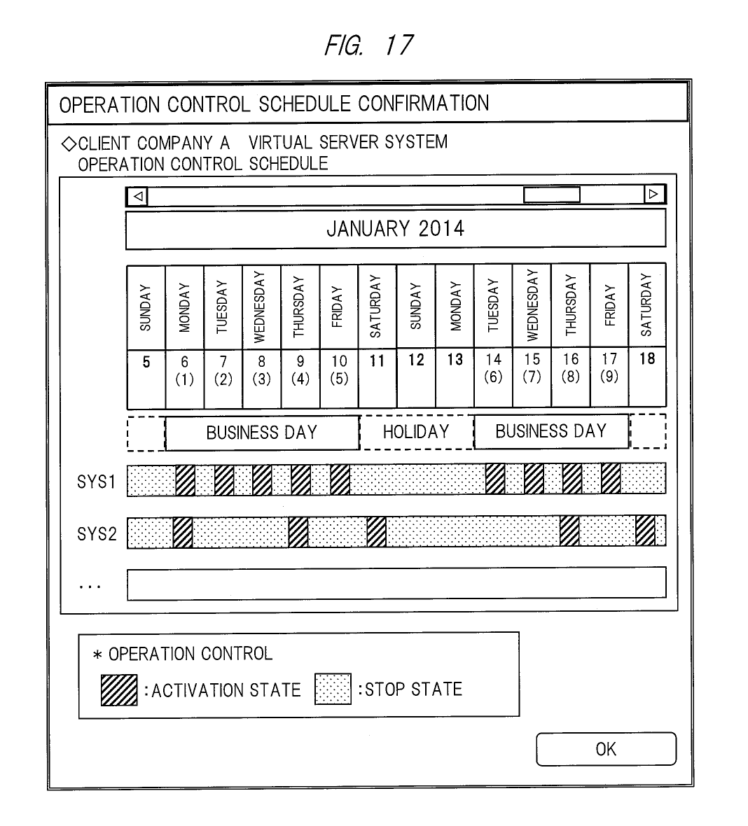

FIG. 17 illustrates an example of a confirmation screen for an operation control schedule. The UI unit 11 provides a confirmation screen which, as shown in FIG. 17, displays a time-series chart and a list of the content of the schedule information 54 created by the schedule creating unit 12 or the content of the operation control schedule executed in the past. In the screen example of FIG. 17, regarding the operation control schedule for the plurality of virtual server systems 6 {SYS1, SYS2, . . . } for the client company A, the date and time of the calendar of the client company A are displayed in a horizontal axis while the respective operation control schedules of virtual server systems 6 are displayed in parallel with each other in a vertical axis. In each of the operation control schedules of the virtual server systems 6, the date and time for the “activation state” which is the action state and the date and time for the “stop state” time are displayed in respective regions in accordance with the date and time of the calendar. Note that the example of FIG. 17 corresponds to the above-described setting examples of FIGS. 9 to 16.

On the present screen, information of the activation or stop action time or information of time of each action state may be displayed. On the present screen, the operating time of the virtual server 70 may be calculated and displayed. On the present screen, the user can understandably confirm the operation control schedule of each virtual server system 6, etc.

[Operation Control Example]

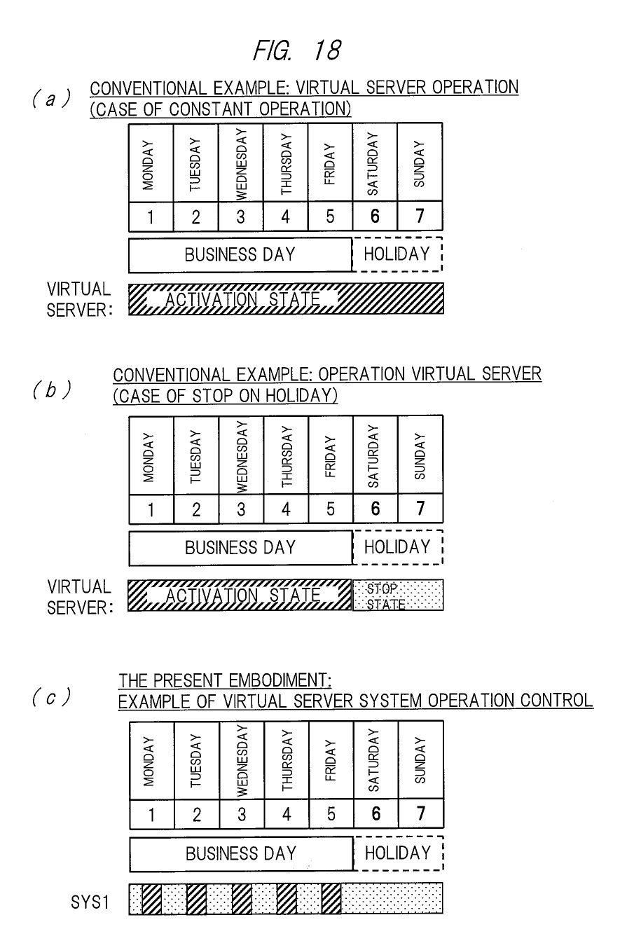

FIG. 18 illustrates an operation control example and its effect according to the virtual server operation control system of one embodiment, in comparison with conventional operation control examples. FIG. 18(a) illustrates an example of constant operation as the operation control for the virtual server in a first conventional example. In this example, all the target virtual servers are constantly activated on all days including the business days which are Monday to Friday and the holidays which are Saturday and Sunday. In this case, in a unit for one virtual server, operating time per day is 24 hours, and operating time per month (the days are set to 30 days) is 30×24=720 hours. In this case, the cost to be paid as much as the client uses is high as described above.

FIG. 18(b) illustrates an example in a case of stoppage on the holidays which are Saturday and Sunday as a second conventional example of the operation control for the virtual server. In this example, the virtual server is activated on the business days which are Monday to Friday, and are stopped on the holidays which are Saturday and Sunday. In this case, in a unit for one virtual server, operating time per week is 5×24=120 hours, and operating time per month (the business days are set to 20 days) is 20×24=480 hours.

FIG. 18(c) illustrates an example of the operation control for the virtual server system 6 by the virtual server operation control system of the present embodiment. This example corresponds to the above-described setting example of the virtual server system SYS1. In the example, as a result of the control, the virtual server system SYS1 is activated in a time zone, for example, from 09:00 to 21:00, supporting the business hours in each of business days which are Monday to Friday, and are stopped in other time zone and on holidays. In this control case, in a unit for one virtual server, operating time per day is 12 hours, operating time per week is 5×12=60 hours, and operating time per month (the business days are set to 20 days) is 20×12=240 hours.

As described above, in the present embodiment in comparison with the conventional example, the operating time for the total virtual servers 70 can be reduced, and the cost to be paid as much as the client uses can be reduced. For example, in FIG. 18(c) in comparison with FIG. 18(a), the operating time per month is reduced to 240/720=1/3, and in FIG. 18(c) in comparison with FIG. 18(b), the operating time per month is reduced to 240/480=1/2.

[Effects and Others]

As described above, according to the present embodiment, in performing the control for operations including the activation and stoppage of the virtual server system 6 on such a system as the public cloud 30, normal and detailed control meeting the convenience and time requirements of the client company 2 can be achieved, so that the cost to be paid as much as the client uses can be reduced, and the time and effort for the setting work, and others can be reduced. The present system provides a control method including an automation mechanism of the end process in the stoppage in consideration of characteristics and limitations of each public cloud 30 and each virtual server system 6. The client company 2 uses a desired public cloud 30 and can appropriately control the operation status of each unit virtual server system 6 composed of the plurality of virtual servers 70 along a schedule adjusted to a business work or others.

For the setting administrator of the client company 2, the setting work for operation control can be simply performed with the less time and effort on the setting screen, and the operation control, the schedules, etc., can be understandably confirmed. For the setting administrator, it is not required to enter every operation control schedule in detail, so that various operation controls can be set through a simple operation of selecting holidays, schedule types, etc., in a calendar. For the setting administrator, time and effort for setting and changing a script program for a control instruction several times are not required.

[Modification]

In the foregoing, the present invention has been described based on the embodiments. However, the present invention is not limited to the foregoing embodiments and various modifications and alterations can be made within the scope of the present invention.

As a modification of the embodiment, an aspect in which an existing monitoring system and the virtual server operation control system are combined to cooperate or integrate with each other is also applicable. Even in the case of the cooperation between the above-described operation control function and the existing monitoring function, normal activation/stoppage of the virtual server system 6 can be achieved.

In the existing monitoring system and its monitoring service, the operation statuses of the virtual servers of the public cloud are periodically monitored and checked, and its information is recorded, by using, for example, a monitoring agent provided in the public cloud. The monitoring agent issues, for example, an abnormal notification related to the virtual server. In a conventional example, when the virtual server is stopped, the stoppage of the virtual server may possibly be detected by the monitoring, and the abnormal notification may be issued.

In the above-described cooperation aspect, the operation control unit 13 of the server 10 cooperates with the monitoring service of the existing monitoring system. When stopping the virtual server 70, the operation control unit 13 instructs the monitoring service to “suspend the abnormal notification”, that is, to temporarily invalidate the monitoring function. Following this instruction, the monitoring service suspends the abnormal notification and record for the virtual server that has been detected by the periodical monitoring of the monitoring agent. As a result, also when the virtual server is stopped, the stoppage is recorded as being not abnormal but normal. When activating the virtual server 70, the operation control unit 13 instructs the monitoring service to “cancel the suspension of the abnormal notification”. As a result, after that, the abnormal state is notified and recorded by the monitoring function as usual.

As a modification, the server 10 may be provided into the system for the client company 2 of FIG. 1 as its component. As a modification, a management device managed by the service provider 1 of the server 10 may be newly placed in the public cloud 30, and the server 10 and the management device may cooperate with each other. Also, a processing unit equivalent to the agent 80 may be operated by the management device.

A modification may include an aspect in which a different server, which saves the operation status information 55, etc., is provided in a different location from a location of the server 10 and the public cloud 30 on the internet 4, and in which the server 10 and the agent 80 read/write the operation status information 55 saved in the server.

As a modification, when the control for not only the end process at the time of the stoppage of the virtual server 70 but also a predetermined start process (such as startup of a related process) at the activation of the virtual server is required, the start process may be controlled by the same mechanism as described above.

### INDUSTRIAL APPLICABILITY

The present invention is applicable to a cloud computing system such as public cloud, to an information system of a client company, to a system of a service provider that performs operation maintenance services on an information system of a client company, and to others.

### EXPLANATION OF LETTERS OR NUMERALS

6 . . . Virtual server system, 1 . . . Server, 11 . . . UI unit, 12 . . . Schedule creating unit, 13 . . . Operation control unit, 16 . . . Agent communication IF unit, 30 . . . Public cloud, 31 . . . Physical server, 32 . . . Management device, 41, 42 . . . Terminal, 51 . . . Calendar information, 52 . . . Operation control definition information, 53 . . . Server definition information, 54 . . . Schedule information, 55 . . . Operation status information, 56 . . . Log information, 61 . . . Hardware, 62 . . . Hypervisor, 70 . . . Virtual server, 80 . . . Agent

1. A virtual server operation control system comprising a server device that controls a status of an operation including activation and stoppage of a virtual server system for an organization on a computer system including a public cloud,
wherein the server device includes:
a schedule unit that creates schedule information of control for an operation including activation and stoppage of a virtual server system based on an operation on a terminal of a setting administrator of the organization at a time convenient to the organization; and
a control unit that executes an action of the control for the operation of the virtual server system on the computer system at date and time in accordance with the schedule information,
at date and time of the activation of the virtual server system, the control unit instructs the computer system to activate a plurality of virtual servers making up the virtual server system so that the plurality of virtual servers are activate by the computer system, and confirms completion of the activation from the computer system, and,
at date and time of the stoppage of the virtual server system, the control unit instructs the computer system to stop the plurality of virtual servers making up the virtual server system so that the plurality of virtual servers are stopped by the computer system, and confirms completion of the stoppage from the computer system.

2. The virtual server operation control system according to claim 1,
wherein, when the control unit instructs the computer system to stop the virtual server, the control unit instructs the computer system to execute a predetermined end process for the stoppage so that the end process is executed by the computer system, and receives a notification of completion of the end process from the computer system, and then, instructs the computer system to stop the virtual server so that the virtual server is stopped by the computer system, and confirms completion of the stoppage of the virtual server from the computer system.

3. The virtual server operation control system according to claim 2,
wherein the computer system includes an agent unit that performs a process in cooperation with a control unit of the server device,
the control unit performs a process of writing a status of the control for the operation of the virtual server system as operation status information, and, when the control unit instructs the computer system to stop the virtual server, writes the instruction to execute the predetermined end process for the stoppage, into the operation status information,
when the agent unit refers to the operation status information of the server device, and, when confirming the instruction to execute the end process, executes the end process, and, after the completion of the end process, writes completion of the end process into the operation status information of the server device, and
the control unit refers to the operation status information, and, when confirming the completion of the end process, the control unit instructs the computer system to stop the virtual server.

4. The virtual server operation control system according to claim 1,
wherein the schedule unit sets information of an order in which a plurality of virtual servers making up a virtual server system for the organization are activated and information of an order in which the plurality of virtual servers are stopped,
when the control unit instructs the computer system to activate the virtual server system, the control unit issues an instruction including an order of the activation of the plurality of virtual servers so that the plurality of virtual servers are activated in the order, and,
when the control unit instructs the computer system to stop the virtual server system, the control unit issues an instruction including an order of the stoppage of the plurality of virtual servers to the computer system so that the plurality of virtual servers are stopped in the order.

5. The virtual server operation control system according to claim 1,
wherein, based on an operation on a terminal of a setting administrator of the organization, the schedule unit sets information which includes information of a virtual server system for the organization on a computer system including the public cloud, calendar information including information of a business day and a holiday of the organization, and definition information on an action and execution time of control for operation including activation and stoppage of the virtual server system, the action and execution time being corresponded to a date of the calendar information, and executes a process of creating the schedule information based on the set information.

6. The virtual server operation control system according to claim 5,
wherein the schedule unit saves information of a computer system including each of a plurality of public clouds and information of each of a plurality of virtual servers in one or more virtual server systems for each of a plurality of organizations, and sets one or more public clouds, one or more virtual server systems, and one or more pieces of calendar information being used by the organization so as to correspond to one another, based on the operation on the terminal of the setting administrator of the organization.

7. The virtual server operation control system according to claim 5,
wherein the server device provides a setting screen for setting information of a virtual server system for the organization, the calendar information, and the definition information, based on the operation on the terminal of the setting administrator of the organization.

8. The virtual server operation control system according to claim 1,
wherein, based on the operation on the terminal of the setting administrator of the organization, the server device provides a confirmation screen for confirming a content of the schedule information.

9. The virtual server operation control system according to claim 1,
wherein the control unit records history information including the instructions of the activation and stoppage in the control for the operation of the virtual server system and including error information required when the activation or the stoppage cannot be normally completed, and
the server device provides a confirmation screen for confirming a content of the history information based on the operation on the terminal of the setting administrator of the organization.

10. The virtual server operation control system according to claim 1,
wherein, when the control unit cannot confirm the activation or the stoppage from the computer system in response to the instruction of the activation or the stoppage in the control for the operation of the virtual server system, the control unit transmits a notification of error information to a terminal of the setting administrator, based on setting by the setting administrator.

11. The virtual server operation control system according to claim 3,
wherein, when the activation or the stoppage cannot be normally executed by the computer system in response to the instruction of the activation or the stoppage in control for the operation of the virtual server system, the agent unit transmits a notification of error information to a terminal of the setting administrator, based on setting by the setting administrator.

12. A virtual server operation control program including a program of causing a server device to execute a process, the server device controlling a status of an operation including activation and stoppage of a virtual server system for an organization on a computer system including a public cloud,
wherein the program causes the server device to execute
a scheduling process that creates schedule information on control for an operation including activation and stoppage of a virtual server system based on an operation on a terminal of a setting administrator of the organization at a time convenient to the organization; and
a controlling process that executes an action of the control for the operation of the virtual server system on the computer system at date and time in accordance with the schedule information,
at date and time of the activation of the virtual server system, the controlling process instructs the computer system to activate a plurality of virtual servers making up the virtual server system so that the plurality of virtual servers are activate by the computer system, and confirms completion of the activation from the computer system, and,
at date and time of the stoppage of the virtual server system, the control process instructs the computer system to stop the plurality of virtual servers making up the virtual server system so that the plurality of virtual servers are stopped by the computer system, and confirms completion of the stoppage from the computer system.
